(19) United States
(12) Patent Application Publication
(10) Pub. No.: US 2013/0250340 A1
(43) Pub. Date: Sep. 26, 2013

(54) DETECTION APPARATUS AND METHOD AND IMAGE FORMING APPARATUS

(71) Applicant: Fujio OSAWA, Kanagawa (JP)

(72) Inventor: Fujio OSAWA, Kanagawa (JP)

(73) Assignee: FUJI XEROX CO., LTD., Tokyo (JP)

(21) Appl. No.: 13/557,785

(22) Filed: Jul. 25, 2012

(30) Foreign Application Priority Data
Mar. 23, 2012 (JP) 2012-067531

(51) Int. Cl. G08B 21/18; G06K 15/02

(52) U.S. Cl. 358/1.14; 340/652

(57) ABSTRACT

A detection apparatus includes the following elements. Plural terminals are connected to plural contact points in a one-to-one correspondence, the plural terminals and the plural contact points being arranged in a predetermined direction. A power feeding unit feeds power to a substrate via, among the plural terminals, a first terminal positioned at one end in the predetermined direction and a contact point connected to the first terminal. A detector detects a signal which is supplied from the substrate as a result of feeding power thereto and which is received by, among the plural terminals, a second terminal positioned at the other end opposite the first terminal, via a contact point connected to the second terminal. A determining unit determines whether there is a connection abnormality between the plural terminals and the plural contact points on the basis of whether the signal detected by the detector satisfies a predetermined condition.

### CROSS-REFERENCE TO RELATED APPLICATIONS

This application is based on and claims priority under 35 USC 119 from Japanese Patent Application No. 2012-067531 filed Mar. 23, 2012.

### BACKGROUND

### (i) Technical Field

The present invention relates to a detection apparatus and method and an image forming apparatus.

### SUMMARY

According to an aspect of the invention, there is provided a detection apparatus including the following elements. Plural terminals are connected to plural contact points in a one-to-one correspondence, the plural terminals and the plural contact points being arranged in a predetermined direction. A power feeding unit feeds power to a substrate via, among the plural terminals, a first terminal positioned at one end in the predetermined direction and a contact point connected to the first terminal. A detector detects a signal which is supplied from the substrate as a result of feeding power to the substrate and which is received by, among the plural terminals, a second terminal positioned at the other end opposite the first terminal in the predetermined direction, via a contact point connected to the second terminal. A determining unit determines whether there is an occurrence of a connection abnormality between the plural terminals and the plural associated contact points on the basis of whether the signal detected by the detector satisfies a predetermined condition.

### BRIEF DESCRIPTION OF THE DRAWINGS

An exemplary embodiment of the present invention will be described in detail based on the following figures, wherein:

FIG. 1 illustrates an example of the entire configuration of an apparatus according to an exemplary embodiment;

FIGS. 2A, 2B, and 2C illustrate arrangements of terminals or pins provided in a connecting unit or a cable;

FIGS. 3A through 3D illustrate examples of the connection state between a connecting unit and a cable;

FIG. 4 illustrates a functional configuration of a control unit;

FIG. 5 is a flowchart illustrating the flow of an operation performed by an apparatus according to this exemplary embodiment;

FIGS. 6 and 7 illustrate examples of the related art;

FIG. 8 illustrates an example of the entire configuration of an apparatus according to a first modified example;

FIG. 9 illustrates a range of an output voltage in which the connection state between substrates is considered to be normal;

FIG. 10 is a flowchart illustrating the flow of an operation performed by an apparatus according to the first modified example; and

FIG. 11 illustrates an example of the entire configuration of an image forming apparatus according to a second modified example.

### DETAILED DESCRIPTION

### 1. Exemplary Embodiment

### 1-1. Entire Configuration

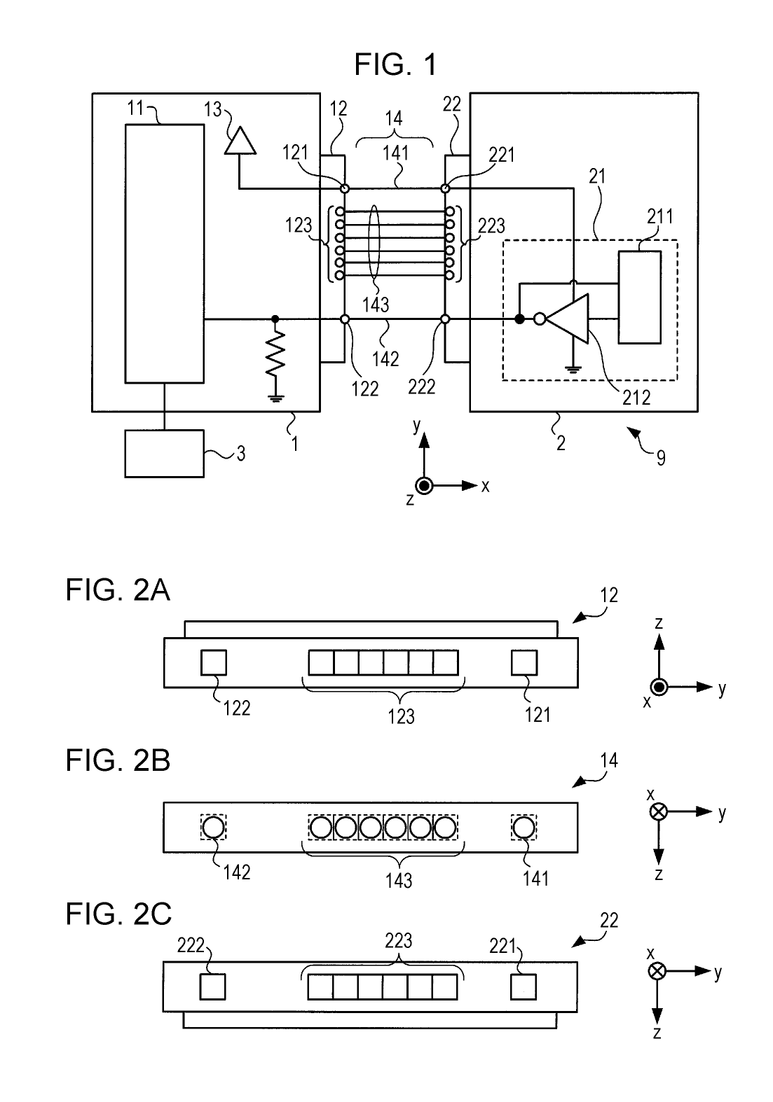

FIG. 1 illustrates the entire configuration of an apparatus 9 according to an exemplary embodiment of the invention. In order to discuss the arrangement of elements which form the apparatus 9, hereinafter, in the drawings, the space in which the elements are disposed is represented using a right-handed xyz coordinate space. Among the coordinate symbols shown in FIG. 1, the symbol represented by a black circle within a white circle indicates an arrow directing from the far side to the near side in the plane of the drawings. The symbol represented by two lines crossing each other within a white circle indicates an arrow directing from the near side to the far side in the plane of the drawings. In the xyz coordinate space, the directions along the x axis are the x axis directions. Among the x axis directions, the direction in which the x component increases will be referred to as a +x direction, while the direction in which the x component decreases will be referred to as a −x direction. Likewise, concerning the y and z components, the y axis directions, the +y direction, the −y direction, the z axis directions, the +z direction, and the −z direction will also be defined in the same manner as those of the x component.

The apparatus 9 is, for example, an image forming apparatus that forms images on a medium, such as paper, by using an electrophotographic system, or an image reading apparatus that optically reads images formed on a medium. The apparatus 9 may be a receiving apparatus that receives broadcast waves and that plays back images and sound corresponding to the received broadcast waves. The apparatus 9 may also be a computer or one of various communication apparatuses. In short, the apparatus 9 may be of any type as long as it has plural substrates connected to each another by using cable lines and implements a certain function as a result of being controlled.

In addition to various elements for implementing the above-described function, the apparatus 9 includes, as shown in FIG. 1, a first substrate 1, a second substrate 2, and a notification unit 3. The first substrate 1 serves to control the apparatus 9 by sending and receiving signals to and from the second substrate 2. The first substrate 1 includes a control unit 11, a connecting unit 12, a power feeding unit 13, and a cable 14.

The notification unit 3 is connected to the control unit 11 of the first substrate 1, and, under the control of the control unit 11, it notifies a user about whether the first substrate 1 and the second substrate 2 are correctly connected. More specifically, the notification unit 3 includes two light emitting elements that emit light of different colors, e.g., green and red, and more specifically, one light emitting element emits light in red and the other light emitting element emits light in green when receiving power. Upon receiving a signal indicating that the first and second substrates 1 and 2 are correctly connected, the notification unit 3 causes a light emitting element to emit light of a color indicating the normal connection state (e.g., green). In contrast, upon receiving a signal indicating the first and second substrates 1 and 2 are not correctly connected, the notification unit 3 causes the other light emitting element to emit light of a color indicating the abnormal connection state (e.g., red).

The control unit 11 includes a central processing unit (CPU), a read only memory (ROM), and a random access memory (RAM). The CPU of the control unit 11 reads and executes a computer program (hereinafter simply referred to as a “program”) stored in a storage device (not shown), such as a hard disk drive, or the ROM, thereby controlling the elements of the apparatus 9.

The first substrate 1 and the second substrate 2 are aligned in the x axis direction and are connected to each other via the cable 14 extending in the x axis direction. The cable 14 is a cable line set or a cable harness through which signals are sent and received between the first and second substrates 1 and 2 and power is supplied from the first substrate 1 to the second substrate 2. The cable 14 includes a power feeding line 141, an inspection signal line 142, and a signal line set 143. The power feeding line 141 is a line through which power is supplied (fed). The inspection signal line 142 is a cable line for transmitting a signal which represents information to be supplied from the second substrate 2 to the first substrate 1 and which is also used for inspecting whether the first and second substrates 1 and 2 are connected is transmitted.

The signal line set 143 is constituted by plural cable lines through which plural signals that are sent and received between the first and second substrates 1 and 2 are transmitted. In this exemplary embodiment, as shown in FIG. 1, the signal line set 143 is a bundle of six signal lines. All the signal lines extend in the x axis direction and are arranged in the y axis direction. The power feeding line 141 is positioned on the +y direction side of the signal line set 143, while the inspection signal line 142 is positioned on the −y direction side of the signal line set 143. At both ends of the cable 14, pins corresponding to the power feeding line 141, the inspection signal line 142, and the individual cable lines of the signal line set 143 are provided. These pins are contact points formed in a projecting shape and are inserted into terminals provided in the connecting unit 12 of the first substrate 1 and into terminals provided in a connecting unit 22 of the second substrate 2.

The power feeding unit 13 feeds power to the second substrate 2 via the power feeding line 141. The connecting unit 12 is a connector for connecting the control unit 11 and the second substrate 2 via the cable 14. The connecting unit 12 includes a power feeding terminal 121, an inspection signal terminal 122, and a signal terminal set 123.

The power feeding terminal 121 is a terminal formed in a recessed shape, and receives a pin provided in the power feeding line 141 of the cable 14. With the connection of the terminal and the pin, the power feeding terminal 121 and the power feeding line 141 are connected. The power feeding terminal 121 is connected to the power feeding unit 13 and feeds power supplied from the power feeding unit 13 to the power feeding line 141.

The inspection signal terminal 122 is a terminal formed in a recessed shape, and receives a pin provided in the inspection signal line 142 of the cable 14. With the connection of the terminal and the pin, the inspection signal terminal 122 and the inspection signal line 142 are connected. The inspection signal terminal 122 is connected to a predetermined port of the control unit 11, and receives a signal output from the second substrate 2 via the inspection signal line 142 and transmits the received signal to the control unit 11.

The signal terminal set 123 includes plural (six in this case) terminals formed in a recessed shape, and the terminals receive pins provided in the associated signal lines of the signal line set 143 of the cable 14. With the connection of the terminals and the pins, the terminals of the signal terminal set 123 and the associated signal lines of the signal line set 143 are connected. The terminals of the signal terminal set 123 are connected to the control unit 11 (not shown), and receive various signals output from the second substrate 2 via the signal line set 143 and transmit the received signals to the control unit 11.

The second substrate 2 causes a certain element of the apparatus 9 to perform signal processing so as to control the element. The second substrate 2 includes an inspection unit 21 and the connecting unit 22. The inspection unit 21 is an oscillation circuit that generates a signal for inspecting whether the first and second substrates 1 and 2 are connected (hereinafter such a signal will be referred to as an “inspection signal”). The inspection unit 21 includes a sensor 211 and an inverter 212. The sensor 211 is, for example, a humidity sensor, and measures the humidity around the sensor 211 and outputs a measurement result in the form of a digital signal. The inverter 212 converts a digital signal output from the sensor 211 into a square wave inspection signal. That is, upon receiving power, the inspection unit 21 generates, as an inspection signal, a signal which has been adjusted such that a change in the signal is contained within a predetermined range.

The connecting unit 22 includes a power feeding terminal 221, an inspection signal terminal 222, and a signal terminal set 223. The power feeding terminal 221 is a terminal formed in a recessed shape, and receives a pin provided in the power feeding line 141 of the cable 14. With the connection of the terminal and the pin, the power feeding terminal 221 and the power feeding line 141 are connected. The power feeding terminal 221 is connected to the inspection unit 21, and feeds power supplied from the power feeding unit 13 of the first substrate 1 via the power feeding line 141 of the cable 14 to the inspection unit 21.

The inspection signal terminal 222 is a terminal formed in a recessed shape, and receives a pin provided in the inspection signal line 142 of the cable 14. With the connection of the terminal and the pin, the inspection signal terminal 222 and the inspection signal line 142 are connected. The inspection signal terminal 222 is connected to the inspection unit 21, and supplies an inspection signal output from the inspection unit 21 to the first substrate 1 via the inspection signal line 142.

The signal terminal set 223 includes plural (six in this case) terminals formed in a recessed shape, and the terminals receive pins provided in the associated signal lines of the signal line set 143. With the connection of the terminals and the pins, the terminals of the signal terminal set 223 and the associated signal lines of the signal line set 143 are connected. The terminals of the signal terminal set 223 are connected to certain elements of the second substrate 2 which implement various functions, and send and receive control signals and signals representing various items of information to and from the elements of the second substrate 2.

### 1-2. Connecting Unit

FIGS. 2A and 2C respectively illustrate the arrangements of the terminals provided in the connecting units 12 and 22 of the first and second substrates 1 and 2. FIG. 2B illustrates the pins provided in the cable 14. When viewing the connecting unit 12 of the first substrate 1 from the second substrate 2, as shown in FIG. 2A, the power feeding terminal 121, the inspection signal terminal 122, and the signal terminal set 123 are sequentially disposed in the order of the inspection signal terminal 122, the signal terminal set 123, and the power feeding terminal 121 in the +y direction.

When viewing one end of the cable 14 from the first substrate 1, as shown in FIG. 2B, the power feeding line 141, the inspection signal line 142, and the signal line set 143 are sequentially disposed in the order of the inspection signal line 142, the signal line set 143, and the power feeding line 141 in the +y direction.

When viewing the connecting unit 22 of the second substrate 2 from the first substrate 1, as shown in FIG. 2C, the power feeding terminal 221, the inspection signal terminal 222, and the signal terminal set 223 are sequentially disposed in the order of the inspection signal terminal 222, the signal terminal set 223, and the power feeding terminal 221 in the +y direction.

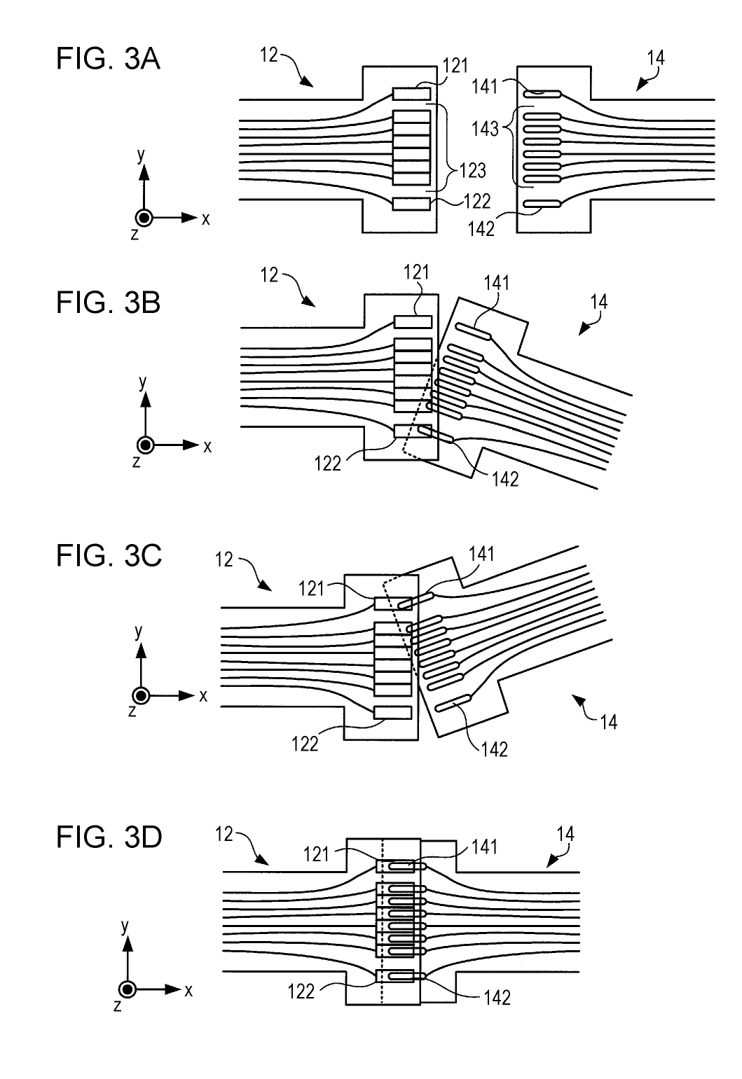

FIGS. 3A through 3D illustrate examples of the connection state between the connecting unit 12 and the cable 14. Although a description will be given of the connection between the connecting unit 12 and the cable 14, the connection between the connecting unit 22 and the cable 14 is similar to that between the connecting unit 12 and the cable 14. A description will be given below, assuming that the connecting unit 22 and the cable 14 are correctly connected.

Assuming that the cable 14 belongs to the second substrate 2, plural pins which are provided in the cable 14 and which are to be connected to the associated terminals provided in the connecting unit 12 are examples of plural contact points which are arranged in a predetermined direction and which are to be connected to the associated terminals of the first substrate 1 in one-to-one correspondence.

Conversely, assuming that the cable 14 belongs to the first substrate 1, plural pins which are provided in the cable 14 and which are to be connected to the associated terminals provided in the connecting unit 22 are examples of plural terminals which are provided in the first substrate 1 and which are arranged in a predetermined direction. In this case, the terminals provided in the connecting unit 22 of the second substrate 2 are examples of contact points which are arranged in a predetermined direction and which are to be connected to the associated terminals of the first substrate 1 in one-to-one correspondence.

When viewing the connecting unit 12 and the cable 14 from above, i.e., from the +z direction to the −z direction, as shown in FIG. 3A, the terminals provided in the connecting unit 12 and the pins provided in the cable 14 are all arranged in the y axis direction. The cable 14 is inserted into the connecting unit 12 such that the pins of the cable 14 fit into the associated terminals of the connecting unit 12.

If the cable 14 is obliquely inserted into the connecting unit 12, the cable 14 and the connecting unit 12 are partially connected, as shown in FIG. 3B. In the connection state shown in FIG. 3B, although the inspection signal terminal 122 and the inspection signal line 142 are connected, the power feeding terminal 121 and the power feeding line 141 are not connected. Accordingly, since power is not supplied to the inspection unit 21, an inspection signal is not output from the inspection unit 21, and thus, the inspection signal terminal 122 does not receive an inspection signal. As a result, the control unit 11 does not detect any inspection signal.

The cable 14 may be obliquely inserted into the connecting unit 12 in a direction opposite to that shown in FIG. 3B, in which case, the cable 14 and the connecting unit 12 are partially connected, as shown in FIG. 3C. In the connection state shown in FIG. 3C, although the power feeding terminal 121 and the power feeding line 141 are connected, the inspection signal terminal 122 and the inspection signal line 142 are not connected. Accordingly, although power is supplied to the inspection unit 21, an inspection signal output from the inspection unit 21 is not transmitted to the inspection signal terminal 122. As a result, the control unit 11 does not detect any inspection signal.

The connection state between the cable 14 and the connecting unit 12 obtained as a result of inserting the cable 14 into the connecting unit 12 in such a manner that that all the terminals of the connecting unit 12 are connected to the pins of the cable 14 is shown in FIG. 3D. In the connection state shown in FIG. 3D, the power feeding terminal 121 and the power feeding line 141 are connected, and also, the inspection signal terminal 122 and the inspection signal line 142 are connected. Accordingly, power is supplied to the inspection unit 21, and an inspection signal output from the inspection unit 21 is supplied to the control unit 11 via the inspection signal terminal 122, thereby allowing the control unit 11 to detect the inspection signal. Additionally, the terminals of the signal terminal set 123 disposed between the power feeding terminal 121 and the inspection signal terminal 122 are all connected to the associated pins of the cable 14. Thus, the elements provided in the second substrate 2 are controlled by the control unit 11 of the first substrate 1.

### 1-3. Functional Configuration of Control Unit

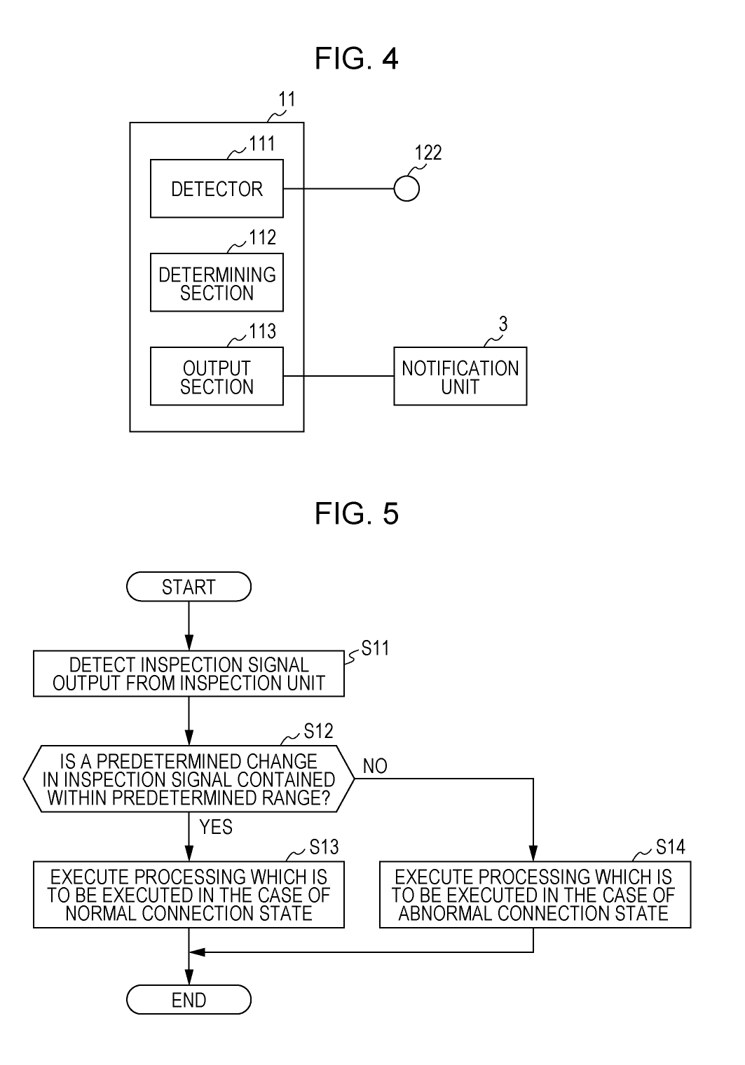

FIG. 4 illustrates the functional configuration of the control unit 11. The control unit 11 functions as a detector 111, a determining section 112, and an output section 113 by executing a program. The detector 111 detects a signal transmitted from the inspection signal terminal 122. The determining section 112 determines whether a signal detected by the detector 111 satisfies predetermined conditions. More specifically, the determining section 112 determines whether a change in the signal detected by the detector 111 is contained within a predetermined range. A change in the signal is a fluctuation in a potential or a current represented by the signal. If a change in the signal is contained within a predetermined range, the determining section 112 determines that the signal satisfies the predetermined conditions and that the detector 111 has detected an inspection signal supplied from the second substrate 2.

The output section 113 outputs a signal indicating a determination result obtained from the determining section 112 to the notification unit 3. For example, if the determining section 112 determines that a change in the signal is contained within a predetermined range, the output section 113 outputs a signal indicating that the first substrate 1 and the second substrate 2 are correctly connected to the notification unit 3. If the determining section 112 determines that a change in the signal is not contained within a predetermined range, the output section 113 outputs a signal indicating the occurrence of an abnormality in the connection state between the first and second substrates 1 and 2 to the notification unit 3. The notification unit 3 then causes the light emitting element of the color corresponding to the received signal to emit light, thereby notifying a user about whether the first substrate 1 and the second substrate 2 are correctly connected. The notification unit 3 may cause a light emitting element to emit light only when the connection state between the first and second substrates 1 and 2 is normal. Alternatively, only when the connection state between the first and second substrates 1 and 2 is abnormal, may the notification unit 3 cause the corresponding light emitting element to emit light. In short, upon receiving a signal indicating an abnormality of the connection, the notification unit 3 lets the user recognize such an abnormality.

### 1-4. Operation

FIG. 5 is a flowchart illustrating the flow of an operation performed by the apparatus 9 according to this exemplary embodiment. In step S11, the control unit 11 of the first substrate 1 detects an inspection signal output from the inspection unit 21 provided in the second substrate 2. Then, in step S12, the control unit 11 determines whether the detected inspection signal has a predetermined change and whether the predetermined change is contained within a predetermined range. If the control unit 11 determines in step S12 that the predetermined change is contained within a predetermined range, the process proceeds to step S13. In step S13, the control unit 11 executes processing which is to be executed when the connection state between the first and second substrates 1 and 2 is normal. The processing executed in step S13 may be the measurement of the frequency of the inspection signal. Alternatively, the control unit 11 may cause the notification unit 3 to notify a user that the connection state is normal.

On the other hand, if the control unit 11 determines in step S12 that the predetermined change is not contained within a predetermined range, the process proceeds to step S14. In step S14, the control unit 11 executes processing which is to be executed when the connection state between the first and second substrates 1 and 2 is abnormal. In the processing executed in step S14, the control unit 11 causes the notification unit 3 to notify a user about the occurrence of an abnormality in the connection state between the first and second substrates 1 and 2.

In order to discuss the features of the apparatus 9 of this exemplary embodiment, the apparatus 9 will be compared with those of the related art. If the control unit 11 merely determines whether none of the terminals of the connecting unit 12 are connected to the pins of the cable 14, as shown in FIG. 3A, it is sufficient that any combination of a terminal and a pin be used for detecting the connection state. In reality, however, as shown in FIG. 3B or 3C, the connecting unit 12 and the cable 14 are partially connected such that the cable 14 is obliquely inserted into the connecting unit 12. In such an obliquely connected state, even if some terminals are connected to the associated pins at one end in the arrangement direction of the cable lines, some terminals are not correctly connected to the associated pins at the other end in the arrangement direction of the cable lines. Accordingly, if only one combination of a terminal and a pin is used for detecting the connection state, such an obliquely connected state may be wrongly recognized as the correct connection state.

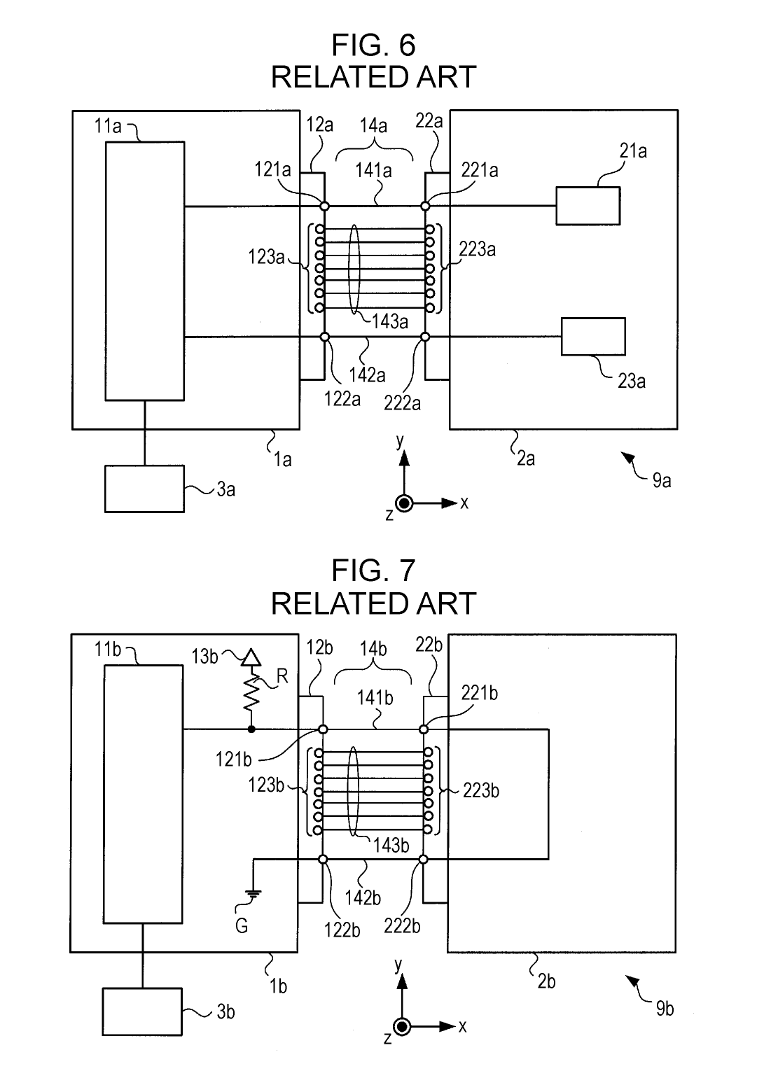

In view of this situation, the following technique has been developed in the related art. The connection state at both ends in the arrangement direction of the cable lines is monitored, and only when both the connection state is normal, will it be determined that the connection state of the cable lines is normal. FIG. 6 illustrates an apparatus 9a of an example of the related art. The apparatus 9a shown in FIG. 6 includes a first substrate 1a, a second substrate 2a, and a notification unit 3a.

The first substrate 1a, which controls the apparatus 9a, includes a control unit 11a, a connecting unit 12a, and a cable 14a. The control unit 11a includes a CPU, a ROM, and a RAM, and controls the elements forming the apparatus 9a as a result of the CPU reading and executing a program stored in, for example, the ROM.

The cable 14a is a cable line set or a cable harness through which signals are sent and received between the first and second substrates 1a and 2a and power is supplied from the first substrate 1a to the second substrate 2a. The cable 14a includes a first inspection signal line 141a, a second inspection signal line 142a, and a signal line set 143a.

The connecting unit 12a includes a first inspection signal terminal 121a, a second inspection signal terminal 122a, and a signal terminal set 123a. The first inspection signal terminal 121a is connected to the first inspection signal line 141a. The second inspection signal terminal 122a is connected to the second inspection signal line 142a. The terminals of the signal terminal set 123a are connected to the associated signal lines of the signal line set 143a.

The second substrate 2a causes a certain element provided in the apparatus 9a to perform signal processing so as to control the element. The second substrate 2a includes a first inspection unit 21a, a second inspection unit 23a, and a connecting unit 22a. Both of the first and second inspection units 21a and 23a are circuits that generate signals for inspecting whether the first and second substrates 1 and 2 are connected.

The connecting unit 22a includes a first inspection signal terminal 221a, a second inspection signal terminal 222a, and a signal terminal set 223a. The first inspection signal terminal 221a is connected to the first inspection signal line 141a. The second inspection signal terminal 222a is connected to the second inspection signal line 142a. The terminals of the signal terminal set 123a are connected to the associated signal lines of the signal line set 143a.

The notification unit 3a is connected to the control unit 11a of the first substrate 1a, and, under the control of the control unit 11a, it notifies a user about whether the first substrate 1a and the second substrate 2a are correctly connected.

An inspection signal output from the first inspection unit 21a (hereinafter referred to as a “first inspection signal”) is received by the first inspection signal terminal 121a of the connecting unit 12a after passing through the first inspection signal terminal 221a of the connecting unit 22a and the first inspection signal line 141a of the cable 14a. The first inspection signal received by the first inspection signal terminal 121a is detected by the control unit 11a of the first substrate 1a.

An inspection signal output from the second inspection unit 23a (hereinafter referred to as a “second inspection signal”) is received by the second inspection signal terminal 122a of the connecting unit 12a after passing through the second inspection signal terminal 222a of the connecting unit 22a and the second inspection signal line 142a of the cable 14a. The second inspection signal received by the second inspection signal terminal 122a is detected by the control unit 11a of the first substrate 1a.

The control unit 11a monitors the first and second inspection signals and determines whether each of the first and second inspection signals has a predetermined change. If at least one of the first and second inspection signals does not have a predetermined change, the control unit 11a determines that the connection state between the first and second substrates 1a and 2a is abnormal. If a predetermined change is identified in both the first and second inspection signals, the control unit 11a determines that the connection state between the first and second substrates 1a and 2a is normal.

In the related art shown in FIG. 6, two inspection units are provided in the second substrate 2a. Accordingly, in order to send first and second inspection signals from the first and second inspection units 21a and 23a, respectively, to the first substrate 1a, it is necessary to assign different cable lines to the first and second inspection units 21a and 23a. Both of the first and second inspection units 21a and 23a may be used as a sensor provided in the second substrate 2a, in which case, however, at least two signals are necessary to be sent from the second substrate 2a to the first substrate 1a. That is, more restrictions are imposed on the configuration of the apparatus 9a shown in FIG. 6 than that of the apparatus 9. Accordingly, in order to send and receive the same amount of signals in the apparatus 9a shown in FIG. 6 as that in the apparatus 9, it is necessary that the number of signal lines of the signal line set 143a be greater than that of the signal line set 143 by one, the number of terminals of the signal terminal set 123a be greater than that of the signal terminal set 123 by one, and the number of terminals of the signal terminal set 223a be greater than that of the signal terminal set 223 by one. Additionally, in the related art shown in FIG. 6, it is necessary to provide ports used for individually detecting the first and second inspection signals for the control unit 11a of the first substrate 1a.

FIG. 7 illustrates an apparatus 9b of another example of the related art, which is different from that shown in FIG. 6. The apparatus 9b shown in FIG. 7 includes a first substrate 1b, a second substrate 2b, and a notification unit 3b. In the apparatus 9b, the first substrate 1b includes a control unit 11b, a connecting unit 12b, a power feeding unit 13b, a pull-up resistor R, and a cable 14b. The second substrate 2b includes a connecting unit 22b but does not have an inspection unit.

The cable 14b is a cable line set or a cable harness through which signals are sent and received between the first and second substrates 1b and 2b and power is supplied from the first substrate 1b to the second substrate 2b. The cable 14b includes a first inspection signal line 141b, a second inspection signal line 142b, and a signal line set 143b.

The connecting unit 12b includes a first inspection signal terminal 121b, a second inspection signal terminal 122b, and a signal terminal set 123b. The first inspection signal terminal 121b is connected to the first inspection signal line 141b. The second inspection signal terminal 122b is connected to the second inspection signal line 142b. The terminals of the signal terminal set 123b are connected to the associated signal lines of the signal line set 143b.

The connecting unit 22b includes a first inspection signal terminal 221b, a second inspection signal terminal 222b, and a signal terminal set 223b. The first inspection signal terminal 221b is connected to the first inspection signal line 141b. The second inspection signal terminal 222b is connected to the second inspection signal line 142b. The terminals of the signal terminal set 223b are connected to the associated signal lines of the signal line set 143b.

In the second substrate 2b, the first inspection signal terminal 221b is connected to the second inspection signal terminal 222b. Accordingly, if there is an abnormality of the connection in at least one of the path “first inspection signal terminal 121b→first inspection signal line 141b→first inspection signal terminal 221b” and the path “second inspection signal terminal 222b→second inspection signal line 142b→second inspection signal terminal 122b”, a high level voltage is applied to the port of the control unit 11b of the first substrate 1b by a combination of the power feeding unit 13b and the pull-up resistor R. Conversely, if the terminals and the lines are correctly connected in both of the above-described paths, a low level voltage is applied to the port of the control unit 11b since the distal end of these paths is connected to a grounding point G. In this manner, the control unit 11b detects an abnormality of the connection state between the first and second substrates 1b and 2b by monitoring the level of the voltage applied to the port of the control unit 11b.

In the related art shown in FIG. 7, it is sufficient that only one port for detecting inspection signals be provided in the control unit 11b, and no inspection unit is provided in the second substrate 2b. In the related art shown in FIG. 7, however, a determination as to whether the connection state between the first and second substrates 1b and 2b is normal is made by using a current flowing back and forth between the first and second substrates 1b and 2b. Thus, as in the related art shown in FIG. 6, in order to determine the connection state, two signal lines are necessary. Accordingly, in order to send and receive the same amount of signals in the apparatus 9b shown in FIG. 7 as that in the apparatus 9, it is necessary that the number of signal lines of the signal line set 143b be greater than that of the signal line set 143 by one, the number of terminals of the signal terminal set 123b be greater than that of the signal terminal set 123 by one, and the number of terminals of the signal terminal set 223b be greater than that of the signal terminal set 223 by one. That is, in the related art shown in FIG. 6 or 7, the two cable lines positioned at the ends in the arrangement direction of the cable lines are used only for detecting the connection state between the terminals and lines. Accordingly, communication between the first substrate 1a or 1b and the second substrate 2a or 2b has to be made by using the remaining cable lines other than the above-described two cable lines.

Unlike the above-described related art, in the apparatus 9, the connection state on the +y direction side is detected by the power feeding line 141 through which power is supplied from the first substrate 1 to the second substrate 2, while the connection state on the −y direction side is detected by the inspection signal line 142 through which an inspection signal is sent from the second substrate 2 to the first substrate 1. The inspection unit 21 may supply any signal to be sent from the second substrate 2 to the first substrate 1, and thus, it may be used for purposes other than the detection of inspection signals. For example, the inspection unit 21 may supply humidity information to the control unit 11, as described above. That is, in the apparatus 9, two cable lines positioned at two ends in the arrangement direction of the cable lines are used for detecting the connection state, however, one of the two cable lines may also be used for another purpose. Accordingly, a smaller number of cable lines are required than in the related art. Additionally, in the apparatus 9, in order to detect inspection signals, the provision of only one port is sufficient for the control unit 11.

### 2. Modified Examples

The exemplary embodiment has been discussed above. This exemplary embodiment may be modified as in the following modified examples. The following modified examples may also be combined.

### 2-1. First Modified Example

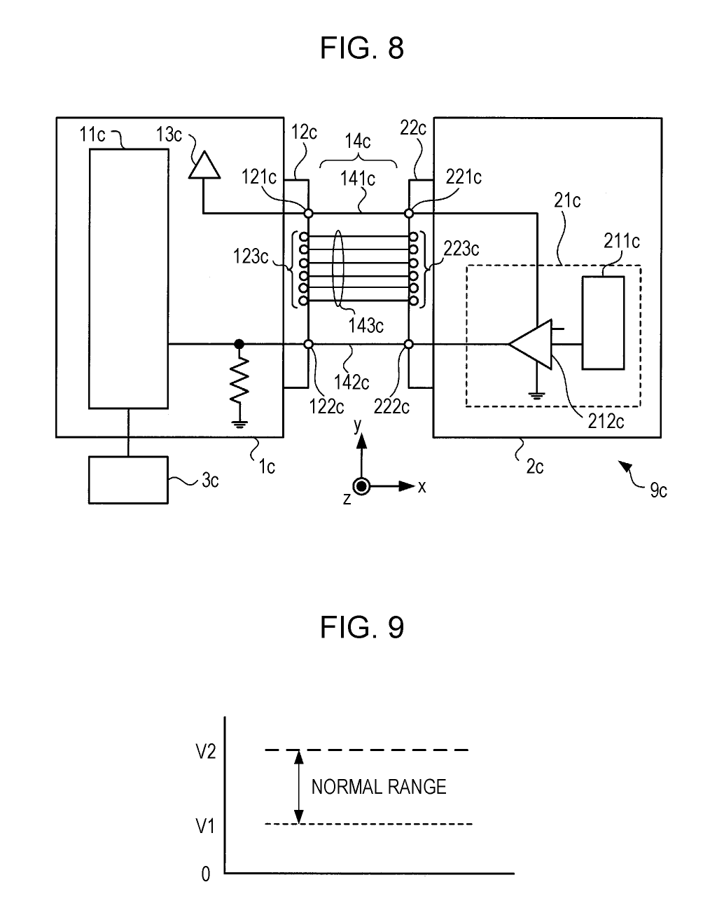

In the above-described exemplary embodiment, an inspection signal is a square wave signal converted from a digital signal. However, an inspection signal does not have to be a digital signal which changes in a manner as described above, for example, it may be a signal indicating an analog value. FIG. 8 illustrates the entire configuration of an apparatus 9c according to a first modified example in which an analog signal is utilized. The configuration of the apparatus 9c is the same as that of the apparatus 9, and the individual elements forming the apparatus 9c are denoted by like reference numerals appended with “c”. The apparatus 9c is different from the apparatus 9 in that an inspection signal output from an inspection unit 21c is an analog signal. The inspection unit 21c is a circuit that generates an inspection signal for inspecting whether first and second substrates 1c and 2c are correctly connected. The inspection unit 21c includes a sensor 211c and an amplifier 212c.

The sensor 211c is, for example, a humidity sensor, and measures the humidity around the sensor 211c and outputs a voltage indicating a measurement result to the amplifier 212c. The amplifier 212c amplifies the voltage supplied from the sensor 211c and outputs the amplified voltage. In the amplifier 212c, the offset voltage is adjusted so that the voltage output from the inspection unit 21c (hereinafter referred to as an “output voltage”) is contained within a range from V1 to V2. The output voltage is transmitted to a control unit 11c via an inspection signal terminal 222c, an inspection signal line 142c, and an inspection signal terminal 122c. The control unit 11c determines on the basis of the value of the received voltage whether the connection state between the first and second substrates 1c and 2c is normal.

FIG. 9 illustrates a range of the output voltage (hereinafter referred to as the “normal range”) in which the connection state of the first and second substrates 1c and 2c is considered to be normal. If there is a break between a power feeding terminal 121c and a power feeding line 141c or between the power feeding line 141c and a power feeding terminal 221c, power is not supplied to the inspection unit 21c, and thus, the voltage output to the control unit 11c becomes 0 V. If there is a break between the inspection signal terminal 222c and the inspection signal line 142c or between the inspection signal line 142c and the inspection signal terminal 122c, power is supplied to the inspection unit 21c and a voltage which is not 0 V is output from the inspection unit 21c. However, since there is a break on the downstream side of the inspection unit 21c, the voltage supplied to the control unit 11c becomes 0 V. That is, regardless of whether there is the occurrence of an abnormality in the path “power feeding terminal 121c→power feeding line 141c→power feeding terminal 221c” or the path “inspection signal terminal 222c→inspection signal line 142c→inspection signal terminal 122c”, a voltage of 0 V is detected by the control unit 11c.

Conversely, if an abnormality is occurring in neither of the two paths, the output voltage output from the inspection unit 21c is adjusted to a range from V1 to V2 by the amplifier 212c. Accordingly, if the received voltage is in a normal range from V1 to V2, as shown in FIG. 9, the control unit 11c determines that the connection state between the first and second substrates 1c and 2c is normal, and if the received voltage is outside this normal range, the control unit 11c determines that the connection state between the first and second substrates 1c and 2c is abnormal. If the control unit 11c determines that the connection state is normal, it obtains a value measured by the sensor 211c of the inspection unit 21c (e.g., a humidity value) on the basis of the value of the above-described voltage.

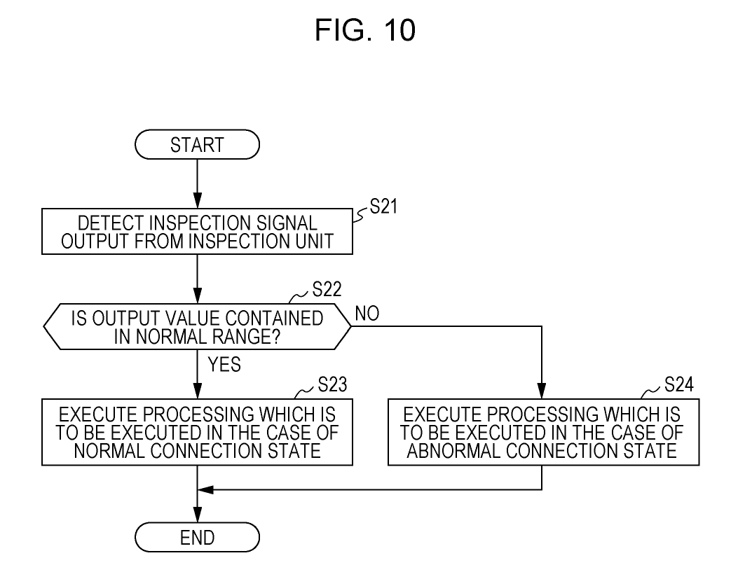

FIG. 10 is a flowchart illustrating the flow of an operation performed by the apparatus 9c according to the first modified example. In step S21, the control unit 11c of the first substrate 1c detects an output value represented by an inspection signal output from the inspection unit 21c of the second substrate 2. In step S22, the control unit 11c determines whether the output value is contained within the normal range. If the result of step S22 is YES, the process proceeds to step S23. In step S23, the control unit 11c executes processing which is to be executed when the connection state between the first and second substrates 1c and 2c is normal. The processing executed in step S23 may be the measurement of the frequency of the inspection signal. Alternatively, the control unit 11 may cause a notification unit 3c to notify a user that the connection state is normal. If the apparatus 9c is an image forming apparatus, in step S23, image forming processing may be continued.

On the other hand, if the control unit 11c determines in step S22 that the output value is not contained within the normal range, the process proceeds to step S24. In step S24, the control unit 11c executes processing which is to be executed when the connection state between the first and second substrates 1c and 2c is abnormal. In the processing executed in step S24, the control unit 11c causes the notification unit 3c to notify a user about the occurrence of an abnormality in the connection state between the first and second substrates 1c and 2c.

In the above-described configuration, as well as in the first exemplary embodiment, an output value detected by the control unit 11c is used for detecting the connection state and also for another purpose. Accordingly, only one cable line is sufficient for transmitting the output value. That is, with this configuration, a smaller number of cable lines are required than in the related art.

### 2-2. Second Modified Example

In the above-described exemplary embodiment, the function and the type of the apparatus 9 are not particularly restricted. If the apparatus 9 is applied to an image forming apparatus 9d that forms images on a medium, the image forming apparatus 9d may be configured as follows.

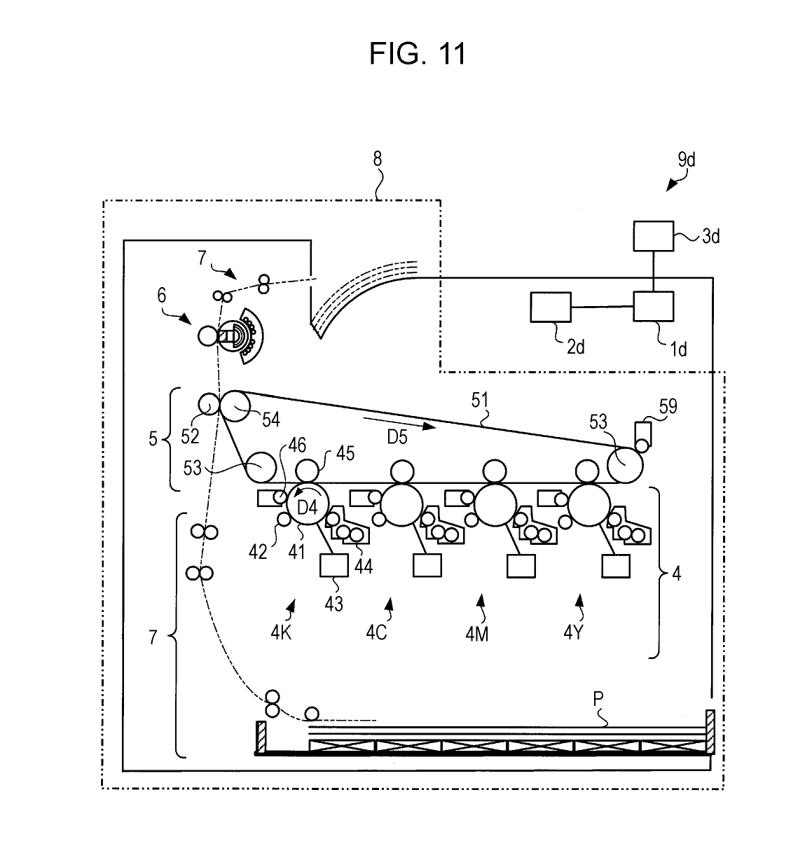

FIG. 11 illustrates the entire configuration of the image forming apparatus 9d according to a second modified example. As shown in FIG. 11, the image forming apparatus 9d includes a first substrate 1d, a second substrate 2d, a notification unit 3d, and an image forming unit 8. The image forming unit 8 includes developing units 4Y, 4M, 4C, and 4K, a transfer unit 5, a fixing unit 6, and a transport unit 7. The alphabetical characters Y, M, C, and K appended to reference numerals 4Y, 4M, 4C, and 4K for the developing devices represent colors of toners, i.e., yellow, magenta, cyan, and black, respectively. The configurations of the developing units 4Y, 4M, 4C, and 4K are roughly the same, except that the colors of toners used in the individual developing units are different. Hereinafter, the developing units 4Y, 4M, 4C, and 4K will be simply referred to as the “developing unit 4” or “developing units 4” by omitting the alphabetical characters unless it is necessary to distinguish between them.

The first substrate 1d serves to control the image forming apparatus 9d and includes a control unit 11d, a connecting unit 12d, a power feeding unit 13d, and a cable 14d. The configurations of the elements forming the first substrate 1d are the same as those of the first substrate 1 of the apparatus 9, and an explanation thereof will thus be omitted.

The second substrate 2d causes the developing unit 4, the transfer unit 5, the fixing unit 6, or the transport unit 7, which forms the image forming apparatus 9d, to perform signal processing so as to control the element that has performed signal processing. The second substrate 2d includes an inspection unit 21d and a connecting unit 22d. The configurations of the elements of the second substrate 2d are the same as those of the second substrate 2 of the apparatus 9, and an explanation thereof will thus be omitted.

The notification unit 3d is connected to the control unit lid of the first substrate 1d, and, under the control of the control unit 11d, it notifies a user about whether the first and second substrates 1d and 2d are correctly connected. The configuration of the notification unit 3d is the same as that of the notification unit 3 of the apparatus 9, and an explanation thereof will thus be omitted.

The transport unit 7 includes a housing section and a transport roller. In the housing section, sheets of paper P, which serve as a medium and which are cut into a predetermined size, are stored. The sheets of paper P are extracted one by one by the transport roller in response to an instruction from the control unit 11d of the first substrate 1d, and are transported to the transfer unit 5 via a sheet transport path. The medium is not restricted to sheets of paper, and may be resin sheets. In short, any type of medium may be used as long as images can be recorded on the surface of a medium.

The developing units 4 each include a photoconductor drum 41, a charging device 42, an exposure device 43, a developing device 44, a first transfer roller 45, and a drum cleaner 46. The photoconductor drum 41 is an image carrier including a charge generating layer and a charge transport layer, and is rotated in the direction indicated by the arrow D4 in FIG. 11 by a driver (not shown). The charging device 42 charges the surface of the photoconductor drum 41. The exposure device 43 includes a laser emitting source, a polygon mirror (neither of which is shown), etc., and under the control of the control unit 11d, it irradiates the photoconductor drum 41 charged by the charging device 42 with laser light corresponding to image data. Then, an electrostatic latent image is formed on each of the photoconductor drums 41. The above-described image data may be obtained from an external device via a communication unit (not shown) by the control unit 11. The external device is, for example, a reader that reads an original image or a storage device that stores therein data representing images.

The developing device 44 includes a two-component developer containing toner of one of Y, M, C, and K colors, and a magnetic carrier, such as ferrite powder. Then, the head of a magnetic brush formed in the developing device 44 is brought into contact with the surface of the photoconductor drum 41, causing toner to adhere to a portion on the surface of the photoconductor drum 41 exposed by the exposure device 43, i.e., image lines of the electrostatic latent image, thereby forming (developing) an image on the photoconductor drum 41.

The first transfer roller 45 generates a predetermined potential difference at a position at which an intermediate transfer belt 51 of the transfer unit 5 opposes the photoconductor drum 41, and whereby transfers an image onto the intermediate transfer belt 51. The drum cleaner 46 removes toner remaining on the photoconductor drum 41 which has not been transferred to the intermediate transfer belt 51 after an image has been transferred, thereby discharging the surface of the photoconductor drum 41. That is, the drum cleaner 46 removes unnecessary toner or electric charge from the photoconductor drum 41 for a subsequent image forming operation.

The transfer unit 5 includes the intermediate transfer belt 51, a second transfer roller 52, belt transport rollers 53, and a backup roller 54. The transfer unit 5 transfers an image formed by the developing unit 4 on a sheet P, the type of which is determined by an operation performed by a user. The intermediate transfer belt 51 is an endless belt member and is stretched by the belt transport rollers 53 and the backup roller 54. At least one of the belt transport rollers 53 and the backup roller 54 is provided with a driver (not shown), and moves the intermediate transfer belt 51 in the direction indicated by the arrow D5 shown in FIG. 11. The belt transport rollers 53 or the backup roller 54 which is not provided with a driver is rotated as a result of being driven by the movement of the intermediate transfer belt 51. By the movement and the rotation of the intermediate transfer belt 51 in the direction indicated by the arrow D5 in FIG. 11, an image on the intermediate transfer belt 51 is moved to a region sandwiched between the second transfer roller 52 and the backup roller 54.

The second transfer roller 52 transfers the image on the intermediate transfer belt 51 onto a sheet P transferred from the transport unit 7, due to a potential difference between the second transfer roller 52 and the intermediate transfer belt 51. A belt cleaner 59 removes toner remaining on the surface of the intermediate transfer belt 51 which has not been transferred to the sheet P. Then, the transfer unit 5 or the transport unit 7 transports the sheet P on which the image has been transferred to the fixing unit 6. The fixing unit 6 fixes the image transferred onto the sheet P by heating. Then, the sheet P is placed on a sheet discharge section provided on the top surface of the image forming apparatus 9d by the transport unit 7.

When the second substrate 2d causes the developing unit 4, the transfer unit 5, the fixing unit 6, or the transport unit 7, which forms the image forming unit 8, to perform signal processing, operating conditions may be changed depending on the humidity of an environment around which the corresponding element is disposed. For example, the developing unit 4 includes the developing device 44 in which toner is contained. Depending on the humidity within the developing device 44, it may be necessary to increase the temperature within the developing device 44 in order to prevent condensation. If the second substrate 2d includes the inspection unit 21d that measures the humidity within the developing device 44 and also includes a controller for controlling a heating element that heats the inside of the developing device 44, the control unit 11d of the first substrate 1d obtains a measurement result output from the inspection unit 21d on the basis of an inspection signal, and sends a control signal to the controller for controlling the heating element in accordance with the obtained measurement result. Then, if the control unit 11d determines on the basis of the inspection signal that the connection state between the first and second substrates 1d and 2d is abnormal, it causes the notification unit 3d to notify a user about the occurrence of an abnormality in the connection state.

### 2-3. Third Modified Example

In the above-described exemplary embodiment, the notification unit 3 notifies a user about whether the connection state between substrates is normal by using two light emitting elements which emit light in different colors. Alternatively, the notification unit 3 may notify a user in another manner. For example, the notification unit 3 may notify a user about whether the connection state is normal by using sound or images or characters displayed on a liquid crystal panel.

The foregoing description of the exemplary embodiment and the modified examples of the present invention has been provided for the purposes of illustration and description. It is not intended to be exhaustive or to limit the invention to the precise forms disclosed. Obviously, many modifications and variations will be apparent to practitioners skilled in the art. The embodiment and the modified examples chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A detection apparatus comprising:
a plurality of terminals that are connected to a plurality of contact points in a one-to-one correspondence, the plurality of terminals and the plurality of contact points being arranged in a predetermined direction;
a power feeding unit that feeds power to a substrate via, among the plurality of terminals, a first terminal positioned at one end in the predetermined direction and a contact point connected to the first terminal;
a detector that detects a signal which is supplied from the substrate as a result of feeding power to the substrate and which is received by, among the plurality of terminals, a second terminal positioned at the other end opposite the first terminal in the predetermined direction, via a contact point connected to the second terminal; and
a determining unit that determines whether there is an occurrence of a connection abnormality between the plurality of terminals and the plurality of associated contact points on the basis of whether the signal detected by the detector satisfies a predetermined condition.

2. The detection apparatus according to claim 1, further comprising:
a notification unit that notifies a user about an occurrence of a connection abnormality if the determining unit determines that there is an occurrence of a connection abnormality,
wherein the substrate supplies, as the signal, a signal which is adjusted such that a change in the signal is contained within a predetermined range, and
the notification unit notifies a user about an occurrence of a connection abnormality if a change in the signal detected by the detector is not contained within the predetermined range.

3. The detection apparatus according to claim 1, further comprising:
a notification unit that notifies a user about an occurrence of a connection abnormality if the determining unit determines that there is an occurrence of a connection abnormality,
wherein the substrate supplies, as the signal, a signal which is adjusted such that a voltage indicated by the signal is contained within a predetermined range, and
the notification unit notifies a user about an occurrence of a connection abnormality if the voltage indicated by the signal detected by the detector is not contained within the predetermined range.

4. An image forming apparatus comprising:
a detection apparatus including
a plurality of terminals that are connected to a plurality of contact points in a one-to-one correspondence, the plurality of terminals and the plurality of contact points being arranged in a predetermined direction,
a power feeding unit that feeds power to a substrate via, among the plurality of terminals, a first terminal positioned at one end in the predetermined direction and a contact point connected to the first terminal,
a detector that detects a signal which is supplied from the substrate as a result of feeding power to the substrate and which is received by, among the plurality of terminals, a second terminal positioned at the other end opposite the first terminal in the predetermined direction, via a contact point connected to the second terminal, and
a determining unit that determines whether there is an occurrence of a connection abnormality between the plurality of terminals and the plurality of associated contact points on the basis of whether the signal detected by the detector satisfies a predetermined condition; and
an image forming unit that includes the substrate that receives power from the power feeding unit and supplies the signal to the detector, and that forms an image on a medium.

5. A detection method comprising:
feeding power to a substrate via, among a plurality of terminals that are connected to a plurality of contact points in a one-to-one correspondence, the plurality of terminals and the plurality of contact points being arranged in a predetermined direction, a first terminal positioned at one end in the predetermined direction and a contact point connected to the first terminal;
detecting a signal which is supplied from the substrate as a result of feeding power to the substrate and which is received by, among the plurality of terminals, a second terminal positioned at the other end opposite the first terminal in the predetermined direction, via a contact point connected to the second terminal; and
determining whether there is an occurrence of a connection abnormality between the plurality of terminals and the plurality of associated contact points on the basis of whether the detected signal satisfies a predetermined condition.
